(19) United States
(12) Patent Application Publication
(10) Pub. No.: US 2017/0278489 A1
(43) Pub. Date: Sep. 28, 2017

(54) Stringed Instrument With Vibrating Rear Diaphragm

(71) Applicant: David B. Wetzel, Laguna Beach, CA (US)

(72) Inventor: David B. Wetzel, Laguna Beach, CA (US)

(21) Appl. No.: 15/466,742

(22) Filed: Mar. 22, 2017

Related U.S. Application Data
(60) Provisional application No. 62/390,215, filed on Mar. 23, 2016.

(51) Int. Cl. G10D 3/02; G10D 3/16; G10D 3/04; G10D 1/08; G10H 3/14; G10H 3/18

(52) U.S. Cl. CPC G10D 3/02; G10H 3/143; G10H 3/185; G10D 3/04; G10D 1/085; G10D 3/163

(57) ABSTRACT

A stringed instrument comprises a substantially hollow body that includes a front soundboard, a rear diaphragm, and a side wall, all defining an internal volume therein that has a first curved interface between the side wall and the front soundboard and a second curved interface between the side wall and the rear diaphragm, such that when the front soundboard vibrates in reaction to the strings being strummed, struck, or picked the rear diaphragm is driven by the side walls and the first and second curved interface. The stringed instrument may take the form of a guitar that includes a primary sound aperture in the front soundboard, a neck having a fretboard with a plurality of frets, a heel fixed at a proximal end thereof, and a string nut at a distal end thereof. A tuning head projects away from the string nut and includes a plurality of tuning mechanisms.

### CROSS-REFERENCE TO RELATED APPLICATIONS

This application claims the benefit of U.S. Provisional Patent Application 62/390,215, filed on Mar. 23, 2016, and incorporated herein by reference.

### STATEMENT REGARDING FEDERALLY SPONSORED RESEARCH AND DEVELOPMENT

Not Applicable.

### FIELD OF THE INVENTION

This invention relates to stringed instruments, and more particularly to guitars, violins, lutes, pianos, harpsichords, drums, and the like.

### DISCUSSION OF RELATED ART

The vibrating strings of a stringed instrument, such as an acoustic guitar, violin or piano, have a much richer and fuller sound when the vibrating strings are mechanically amplified by means of a soundboard. Such traditional instruments do an adequate job of mechanically amplifying such sounds of vibrating strings from the front soundboard for very small ensembles, intimate audiences and halls. However, they do a very poor job of communicating or promoting the volume and enrichment of the sound quality from the front soundboard to the back of the body of the instrument, to produce a larger fuller and richer sound and volume, in order to accommodate larger orchestras, audiences and halls. The vibrations from the front soundboard communicated through the internal air mass of the instrument only barely energize the back and sides of the instrument.

Mechanically, the sound vibrations generated by the front soundboard are cut-off at the rigid 90-degree transition to the sides of these instruments, thus inhibiting a highly efficient means of mechanical propagation of the sound vibrations of the front soundboard from being communicated to the back soundboard. This obstruction of the sound vibrations also stifles the potential for lengthy sustain.

Therefore, a need exists for an instrument that efficiently amplifies the sounds of the vibrating strings with both front, side and rear soundboards by mechanical means. Such a needed invention would provide additional sound-enhancing properties and volume-amplifying capabilities. The present invention accomplishes these objectives.

### SUMMARY OF THE INVENTION

The present invention is a novel stringed instrument that in its simplest form includes a substantially hollow body having an external surface. A front, sides, and a rear driver and diaphragm all define an internal volume and an external surface of a body of the instrument.

The front soundboard has a convex curved crown and internal harp bracing structure with a corresponding curvature that forms the mechanism that drives the rear diaphragm. A first crowned front soundboard and internal bracing system drive a second peripheral, curved, progressive radii that drives a third curved side radii that in turn drives the fourth driver and fifth rear diaphragm, forming a whole-body soundboard matrix.

The front soundboard, having a first curved radius or “crown,” and a second curved interface conjoin the crown to the sides of the body. The sides are a third curved interface that is conjoined to drive the fourth curved rigid compound radius and fifth near-flat but curved elements. Further, recessed within the front of the body is also a shoe, that functions to attach a neck. Beneath the shoe is also a strut element that functions to reinforce the body against and distribute the high tensile force of the strings, the high compressive and torque moments, and sound vibration into the top side and rear soundboards. The fourth curved element is a rigid compound radius driver of the fifth element that is a nearly flat and flexible diaphragm element. Both fourth and fifth elements can move inwardly and outwardly, corresponding to the flexing and vibration of the front soundboard communicated by the second and third curved interfaces of the side wall elements that energize both the fourth driver and fifth diaphragm. That is, the body is comprised of a dynamic mechanically energizing front soundboard, mechanically adjoined through a progressive peripheral radius to interactively energize the sound-producing side elements that drive both the dynamic mechanically energizing and amplifying compound radius, rear driver and diaphragm, to define the whole-body matrix soundboard.

Preferably the front soundboard is resilient and in the shape of a shallow dome, slightly convex outwardly, as such that under tension from the strings, the front soundboard is deformed under extreme tension and preloaded with high levels of potential energy, to a relatively flat configuration and able to deflect inward away from the strings or outward towards the strings as a result of fluctuations of tension and vibration from the strings. As such, a “steel drum effect” or “oil can effect” is established in the front soundboard being in an unstable condition, can be deflected either inward or outward with relative ease. Thereby when the strings, under extreme tension are energized, the front soundboard moves easily back and forth with increased efficiency and excursion, producing higher definition, volume and sustain of notes when played by the user. A plurality of strings is affixed to the body, each adapted to produce a unique sound when plucked or struck.

In the instant embodiment, the stringed instrument takes the form of a guitar. Such a guitar includes a primary sound aperture in the front soundboard, traditionally located between a recessed shoe, fixed in the exterior surface of the body at the distal end from a string bridge. The guitar further includes a neck having a fretless fingerboard or a fretboard with a plurality of frets fixed on a front side thereof. The neck includes a heel fixed at a proximal end thereof and a tuning head at a distal end thereof. Preferably a rear side of the neck is shaped for a comfortable grasp by a user. At the distal end of the neck, a tuning head projects away from the string nut and includes a plurality of tuning machines to fine tune the high tension and pitch of the vibrational tones generated by the strings.

The heel of the neck is adapted for engagement within a shoe of the body, and as such has a plurality of mechanical fasteners embedded within the neck to secure it within the shoe of the body. Also embedded within the neck is a truss rod to counterbalance the high tensile force induced into the neck by the tension of the strings, thereby making the instrument much more effortless and pleasant to play.

Further incorporated within the body and beneath the shoe is a strut support structure, under and part of the shoe, to which the neck is attached, further accommodating the hundreds of pounds of tensile force induced by the strings. In addition are micro adjustment screws within the strut and shoe in the body to further micro adjust the angle of the neck for clearance between the strings and frets, for greater comfort, ease of play and intonation.

The strings in such a guitar embodiment are attached by ball ends to string anchor pins in the bridge and tightly stretched over the saddle, the frets and fret board, and over the string nut, terminating with the tuning mechanisms. When adjusted by the tuning mechanisms, the plucking of at least one of the strings results in sound waves induced, amplified and distributed throughout and emanating from the entirety of exterior surfaces of the body and projected from the sound aperture from the internal volume of the body of the instrument.

On the distal side of the bridge is a primary sound aperture to project the internal sound produced by the instrument. In the alternative, with no primary sound aperture, at least one, preferably two sound apertures are located at the proximal end of the front crowned soundboard, placed on either side of an internal monolithic bracing and sound distribution structure.

In conjunction with the alternative sound aperture placement, the internal volume optionally includes at least one internal “loudhailer” partition and contoured internal surface element that create an expanding switch-back megaphonic horn that leads to at least one alternate second sound aperture in the front soundboard, positioned on an opposing proximal side of the string bridge from the traditional position of the primary sound aperture.

Further, the monolithic bracing and sound vibration distribution structure within the internal volume causes both the vibration-to-sound efficiency and the structural integrity of the body to be increased. In embodiments having a primary single sound aperture or multiple alternative sound holes, there may or may not be internal loudhailer partitions. In the alternate embodiments having a plurality of the alternate sound apertures, such alternate sound apertures may be similar or larger in area than that of a traditional primary sound aperture.

The bridge preferably includes a saddle projecting away from the front soundboard. A distal side and a proximal side of the bridge each slope towards the front soundboard, and the proximal side thereof includes a plurality of string anchor pins each fixed with one of the strings. The string bridge preferably incorporates the saddle and is fixed through the front soundboard to an internal bracing and sound vibration distribution structure that allows the bridge and the saddle to accommodate hundreds of pounds of tensile force and sound vibrations produced by the strings.

The whole-body soundboard matrix further provides a plurality of mount options for active or passive sound reproduction pickup devices, such as a piezo-electric, magnetic or laser pickup devices, each preferably located and centered under the strings and the front soundboard.

The option of using a body standoff fixed over the rear diaphragm is recommended to hold the body of the stringed instrument away from the body of the player, thereby preventing contact which would result in the attenuation in sound, volume and sustain thereof.

The present invention is an instrument that mechanically amplifies the sounds of vibrating strings with both the front soundboard, sides and the rear driver and diaphragm, creating a whole-body soundboard matrix. The present invention may be incorporated into a wide variety of stringed and percussion instruments, including the most basso profoundo to the most soprano in the viola family, the deepest acoustic bass guitar to the most soprano guitar and ukulele in the ukulele, guitar, sitar, lute, etc. families; including all ranges of acoustic pick or percussion instruments in the piano, harpsichord and drum families of instruments. Other features and advantages of the present invention will become apparent from the following more detailed description, taken in conjunction with the accompanying drawings, that illustrate, by way of example, the principles of the invention.

### DESCRIPTION OF THE DRAWINGS

FIG. 1 is a perspective view of one embodiment of the invention, wherein a stringed instrument of the invention takes the form of a guitar;

FIG. 2 is a partial front elevational view of the invention;

FIG. 3 is a side elevational view of a body of the invention, partially broken away, a neck, strings and related elements omitted for clarity of illustration;

FIG. 4 is a partial cross-sectional view of the invention, taken along line 4-4 of FIG. 2;

FIG. 5 is a bottom plan view of the front soundboard; and

FIG. 6 is a partial view of a tuning head of the embodiment of FIG. 1.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

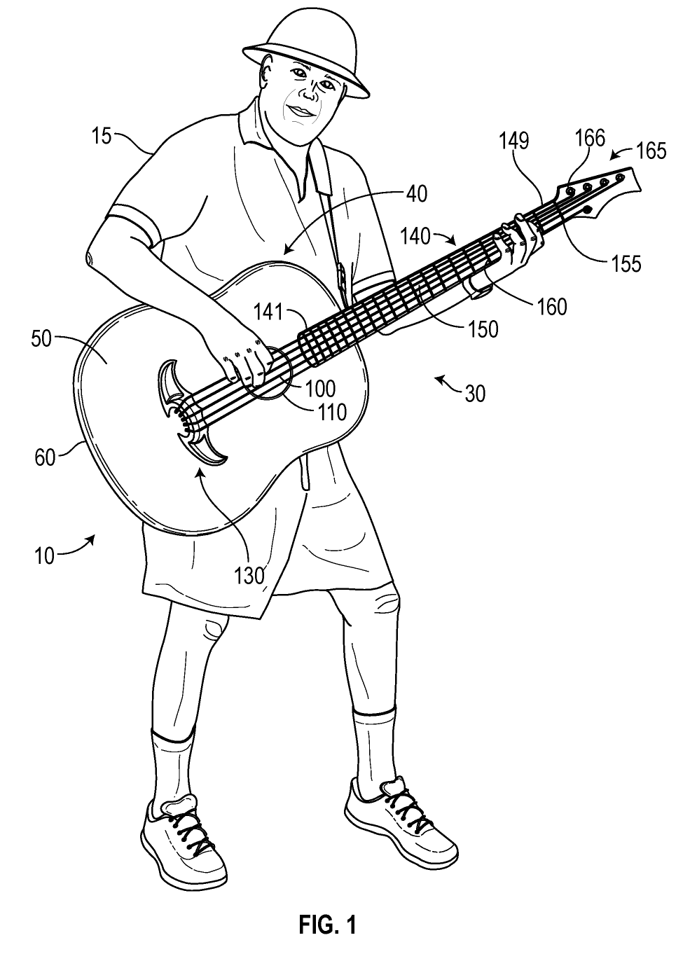

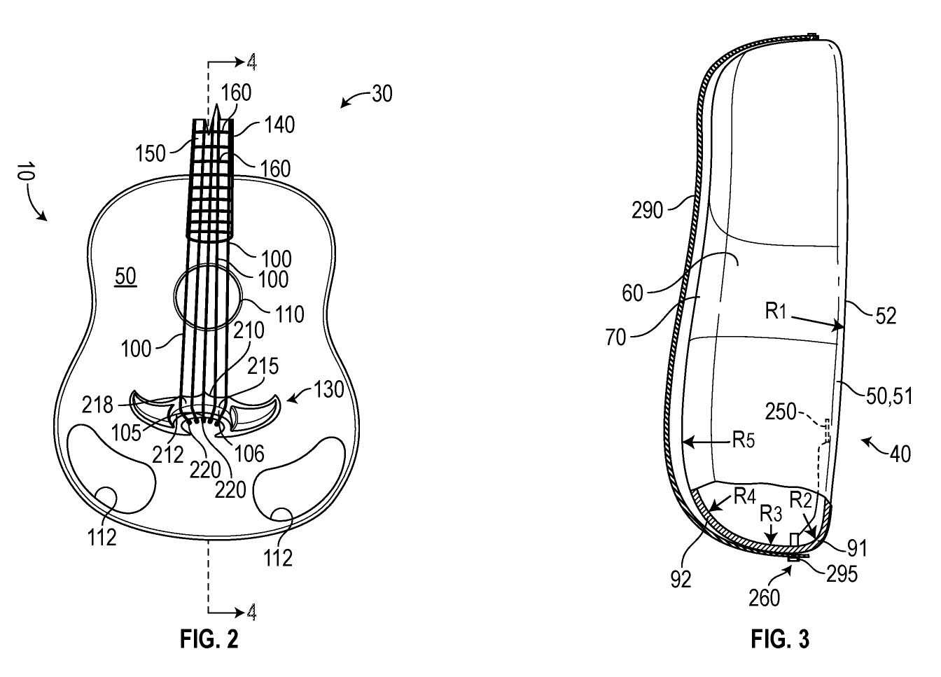

FIGS. 1 and 2 illustrate a stringed instrument 10 that in its simplest form comprises a substantially hollow body 40 that includes a front crown or front soundboard 50 with a first curvature R₁, a rear soundboard 70 having a rear diaphragm 75 that is substantially flat, and a side wall 60. The front soundboard 50, rear soundboard 70, and side wall 60 all define an internal volume 80 that has a second curved interface 91 between the side wall 60 and the front soundboard 50 having a second curvature R₂, a third internal curvature R₃ of the side wall 60, and a fourth curved interface 92 between the side wall 60 and the rear soundboard 75 having a forth curvature R₄. The second curvature R₂, third curvature R₃, and the forth curvature R₄ may connect within the internal volume 80 to form a smooth, continuously curved internal surface at the side wall 60. A plurality of strings 100 are fixed with the body 40 and are each adapted to produce a unique sound when plucked or struck, the vibration thereof transmitted through the front soundboard 50, side wall 60, and into the rear soundboard 70 and rear diaphragm 75 having a fifth curvature R₅ to amplify the sound of the plucked or strummed string 100.

In some embodiments the stringed instrument 10 takes the form of a guitar 30 (FIGS. 1-3). Such a guitar 30 may include a primary sound aperture 110 in the front soundboard 50, preferentially located between a recessed shoe 20 fixed with the body 40 and a string bridge 130. Alternately, instead of the primary sound aperture 110 the front soundboard 50 may include at least one alternate second sound aperture 112 positioned on an opposing side of the string bridge 130 from the primary sound aperture 110 (FIGS. 2 and 5). Such alternate second sound apertures 112 may be included either with or without a switch-backed megaphonic horn 200 described below.

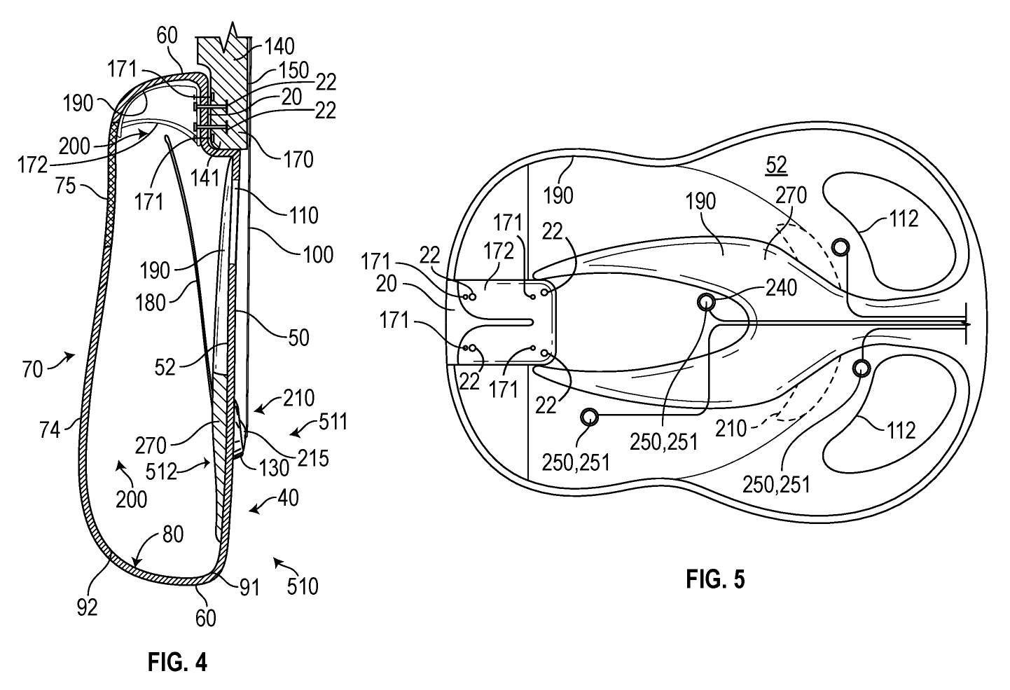

The guitar 30 further includes a neck 140 having a fretboard 150 either fretless or with a plurality of frets 160 fixed at a front side 142 thereof. The guitar 30 further includes a heel 170 fixed at a proximal end 141 thereof, and a string nut 155 at a distal end 149 thereof. The heel 170 (FIG. 4) is adapted for engagement with the shoe 20 of the body 40 that serves to attach the neck 140 to the body 40, such as with a plurality of mechanical fasteners 22 and, optionally, a plurality of micro-adjustment screws 171 fixed with a strut 172 the heel 170 to fine-tune the distance between the nut 155 and saddle 210, a middle point of the string 100 being between the saddle 210 and the string nut 155. A second set of micro-adjustment screws 171 may be included to extend from the strut 172 to adjust the angular slope and clearance between the strings 100 and the frets 160 of the fretboard 150. The strut 172 functions to distribute high tension and string sound vibrations into both the first domed front soundboard 50 and into the fifth curved but nearly flat and flexible diaphragm 75 of the body 40.

A tuning head 165 with a plurality of tuning machines or mechanisms 166 adjusts the tension between the strings 100 and the saddle 210. Preferably a rear side of the neck 140 is curved for comfortable grasping by a user 15.

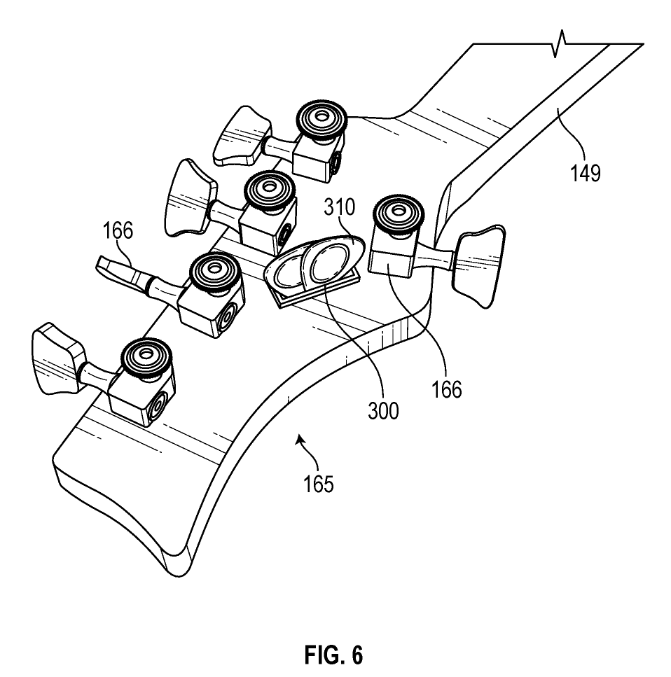

The tuning head 165 (FIG. 6) projects away from the string nut 155 and includes the plurality of tuning mechanisms 166. In one embodiment, a plectrum holder 300 is included on the tuning head 165 for convenient access to a guitar plectrum 310 when needed.

The strings 100 in such a guitar embodiment 30 are stretched between the string anchor pins 220 in the string bridge 130, over the saddle 210, the fret board 150, over the string nut 155, and into the tuning mechanisms 166. As such, strumming at least one of the strings 100 results in sound waves amplifying from within and throughout the entire exterior of the body 40 from the front sound board 50, around the side wall 60, and into the rear soundboard 70 and diaphragm 75, which amplifies the vibrations transmitted from the front soundboard 50 and the rest of the rear soundboard 70. The rear diaphragm 75 is neutrally tensioned, such that vibrations of the strings transmitted directly through the internal volume 80 or through the front soundboard 50 and side wall 60 cause the rear diaphragm 75 to vibrate with a higher amplitude than the front soundboard 50.

Preferably the front soundboard 50 is resilient and in the shape of a shallow dome 51 (FIG. 3), slightly convex outwardly such that under tension from the strings 100 (FIG. 4), the front soundboard 50 is deformed to a relatively flat configuration and able to deflect inward away from the strings 100 or outward towards the strings 100 as a result of tension and vibration from the strings 100. As such, a “steel drum effect” or an “oil can effect” is established with the front soundboard 50 being at an unstable position, a highly-compressed pre-strung potential energy condition that can be deflected at greater excursion either inward or outward relatively easily. The front soundboard 50 moving back and forth results in increased volume when the strings 100 are strummed, and an increased sustain of notes played by the user 15.

An apex 52 of the front soundboard 50, or front crown, is the highest point on a shallow curve of the front soundboard 50. The scale of the neck 140 is the precise distance from the distal side of the saddle 210, to the proximal side of the string nut 155. The scale of the neck 140 is determined by two times the distance from the proximal side of the 12th fret 160 to the proximal side of the string nut 155. The location for the shoe 20 on the body 40 is precisely where the heel 170 of the neck 140 ends in the precisely placed shoe 20 of the body 40. Necks 140 can be made in various lengths and sizes, but this 12th fret rule remains the same. This is a critical position on the body 40 in relation to the position and depth of the heel 170 of the neck 140, the scale and string nut 155, thereby fret positions of the neck 140. The shoe 20 in the body 40 is precisely placed so that the heel 170 of the neck 140 will fall right in place such that the distance from the distal side of the saddle 210 will be the proper distance to proximal side of the string nut 155.

Preferably at least one user standoff 290 (FIG. 3) is fixed with the rear diaphragm 75 and adapted to hold the body 40 of the stringed instrument 10 away from the user 15 to prevent contact therebetween and resulting sound attenuation thereof.

Preferably in such an embodiment the rear diaphragm 75 moves inwardly and outwardly, corresponding to the flexing and vibration transmitted thereto by the shallow dome 51 of the front soundboard 50, the side wall 60 and the rear soundboard 70. The first and second curved interfaces 91,92 of the side wall 60 and the rear soundboard 70 drive the rear diaphragm 75 in such an embodiment.

The internal volume 80 preferably includes a plurality of internal “loudhailer” partitions 180 (FIG. 4) and contoured internal surfaces 190 that create a switch-backed megaphonic horn 200 that leads to the at least one alternate second sound aperture 112 in the front soundboard 50, positioned on an opposing side of the string bridge 130 from the primary sound aperture 110. Further, a monolithic internal harp-style frame 270 (FIG. 5) within the internal volume 80 extends laterally not as far as the bridge 130 and saddle 210, such that the vibration-to-sound efficiency is increased from the strings 100 to the front soundboard 50, and such that the structural integrity of the body 40 is maintained when under tension from the strings 100. The monolithic internal harp-style frame 270, also referred to simply as the harp 270, acts as a sound vibration distribution system with a monolithic internal concave bracing (FIG. 5).

The saddle 210 preferably includes a peak 215 (FIGS. 2 and 4) projecting away from the front soundboard 50. A distal side 218 and a proximal side 212 of the bridge 130 each slope towards the front soundboard 50, and the proximal side 212 thereof includes a plurality of string anchor pins 220 each fixed with one of the strings 100. The string bridge 130 preferably incorporates the saddle 210 and is fixed through the front soundboard 50 to the monolithic internal harp-style frame 270 that allows the bridge 130 and the saddle 210 to accommodate hundreds of pounds of tensional force, such as up to 350 pounds or more, within the strings 100 while also allowing the front soundboard 50 to transfer vibrational energy from the strings 100 to the side wall 60. The string bridge 130 and/or back side 52 of the soundboard 50 preferably further includes a plurality of mounts 240 (FIG. 6) for active or passive sound reproduction pickup devices 250, such as a piezo-electric pickup device 251 and/or under-saddle pickup (not shown), each proximate the strings 100 and the front soundboard 50. Each sound reproduction pickup device 250 is electrically connected with at least one output jack 260 (FIG. 3), which preferably also incorporates a mounting pin 295 for the standoff 290, or a guitar strap (not shown). In one embodiment, piezo-electric fabric (not shown) is laminated between two conductive layers to allow a substantial amount of the body 40 to function as a pickup device 250.

In one embodiment, the string anchor pins 220 allow a barrel-end terminator (not shown) of the strings 100 to directly contact the bridge 130 along a contact area 106 (FIG. 2) thereof, which provides stronger mechanical connection between the bridge 130 and the strings 100 for imparting vibration from the strings 100 to the front soundboard 50.

Preferably the body 40 is made from a composite plastic or resin material having reinforcing laminates either as natural fibers, such as hemp, jute, cotton, rice, and the like, or synthetic fibers such as glass, polyester, nylon, Dacron, carbon, aramid, and the like. The resin material make be, flour and water, airplane glue, Elmer's glue, polyester, epoxy, phenolics, polyimides, polyamides, piezo-electric material, or the like. The process used to form the body may include hand lay-up, resin infusion molding, resin transfer molding, vacuum, injection molding, smash molding, or other similar existing or to-be-developed materials and processes. Other materials and processes may include metal fabrication of all sorts including stainless steel, a full range of steel, titanium, aluminum, other metals and/or alloys, and classic and modern metal and body working processes, including water cutting and forming, as well as super plastic forming. Preferably the wall thickness of the body is as thin as possible without collapsing under playing tensions, such as 0.010″ to 0.100.″

The present invention can function as a whole-body soundboard matrix 510 comprised of an assemblage of the mechanically interactive parts in which string vibration actively drives everything all the way from the string “ball” ends 105 (called ball ends, but are in fact hollow metal barrel ends that fit over the string) that engage the anchor pins 220, saddle 210, bridge 130, a bell crank arrangement or matrix 510 that drives the internal inverse mating crowned, monolithic, harp bracing, and sound distribution element 270, expanding and contracting crown 50 with curvature R₁, circumferential progressive and side radii R₂, R₃, R₄ that drives the floating, rigid compound fifth radii R₅ driver and flexible diaphragm 75.

As an alternate way of describing the invention, the whole body matrix soundboard 510 comprises: a first matrix 511 (FIG. 4), and also referred to as the bell crank and rock and roll, beginning with the barrel end 105 of the vibrating strings 100, imparting their vibration energy of the strings 100, into the string anchor pins 220, into the saddle 210, into the bridge 130 and then into a second matrix 512 which communicates and amplifies the sound vibration energy from the first matrix 511 into a first curved crowned dome 51 and correspondingly curved harp sound vibration distribution and reinforcement system 270, which then imparts and amplifies the sound vibrational energy to a second curved peripheral progressive radii R₂, which amplifies the vibrational energy and imparts it into the third curved side radii R₃, which amplifies and imparts the vibrational energy into both the fourth curved and very rigid compound radius driver 74, and the fifth curved but almost flat and very flexible rear diaphragm 75 which makes up rear soundboard 70.

Fasteners 22 holding the heel 170 of the neck 140 into and attached to the shoe 20 facilitate the attachment of the neck 140 to the body 40 and communicate string tension vibrations that are generated from both the distal end 149 and the proximal end 141 of the neck 140 into the whole body matrix soundboard 510. At the distal end of the front soundboard is the shoe 20, supported by an internal strut 172 with micro adjustment screws 171. The heel 170 of the neck 140 is a focal point of very high tension and vibrations from the strings 100 stretched between the anchor pins 220 in the bridge 130 and the tuning machines or mechanisms 166 at the distal end 149 of the neck 140 and the internal strut 172 while holding the proximal end 141 of the neck 140 into perfect alignment, facilitated by the micro adjustment screws 171. It also reinforces the neck 140 under tension and communicates the sound vibrations communicated through the neck 140 into the heel 170 and thereby the strut 172 and into a distal end of the whole body soundboard matrix 510.

While a particular form of the invention has been illustrated and described, it will be apparent that various modifications can be made without departing from the spirit and scope of the invention. For example, the stringed instrument 10 may take the form of any stringed instrument, including a hollow body acoustic guitar, an acoustic electric guitar or ukulele, a classic style stringed orchestral instrument ranging from the smallest of soprano violins, violas and cellos to a stand-up bass or octo bass. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms.

Accordingly, the inventor reserves the right to add additional claims after filing the application to pursue such additional claim forms for other aspects of the invention.

What is claimed is:

1. A stringed instrument that functions as a whole body soundboard matrix comprised of:
a body including a front soundboard having under neutral tension a first convex crowning radius and a correspondingly mating monolithic internal concave crowned forth curvature bracing system extending from a proximal end of the body to an internal strut at a distal end of the body to maintain the structural integrity of the front soundboard, that also functions as a sound vibration distribution system throughout the front soundboard, the front soundboard further including a string bridge affixed at an apex of the crowned front soundboard;
a piezo-electric pickup affixed within and in close contact with a base of a slot in the top side of the bridge;
string anchoring pins to which a ball/barrel end of a plurality of strings are attached for securing against hundreds of pounds of tension and increased mechanical advantage in energizing the external bridge, saddle, and internal harp, strut, and vibration distribution matrix;
the saddle fixed atop and in close contact with the piezo-electric pickup within the bridge and functioning as a fulcrum to transform fulgurations of string tension variables and mass lifting and compressing of the front soundboard up, down, and sideways,
pulling and releasing fore and aft tension on the bell crank actuating lever/saddle in the slot of the bridge and internal harp bracing, causing a further rocking up and down of the front soundboard;
a neck having a heel at a proximal end thereof, the plurality of strings extending over the neck that further includes a fret board with a plurality of frets and a nut at the distal end, extending to a tuning head, the neck further including on a rear side a plectrum holder and a plurality of tuning mechanisms that penetrate to the front side of the machine head; the strings terminating with the attachments thereto;
the strings attached to the string anchor pins in the bridge and stretched over the saddle, distal end of the body and shoe for securing the neck to the body, which when plucked, create sound potential vibrations that are communicated through a mechanical matrix comprised of;
the saddle energizing the bridge, which energizes first the front crowned soundboard, which then energizes second the circumferential radii, which then energizes third the side wall radii, which then energizes fourth the back compound radii driver and finally fifth the nearly flat diaphragm, all of which define the whole body matrix soundboard with such vibrations further being communicated to the piezo electric pickup under the saddle in the bridge.

2. A stringed instrument, comprising:
a substantially hollow body including a front soundboard, a rear soundboard having a rear diaphragm, and a side wall, all defining an internal volume, the internal volume having a first curved interface between the side wall and the front soundboard having a second curvature, and a second curved interface between the side wall and the rear diaphragm having a forth curvature; and
a plurality of strings fixed with the body, each adapted to produce a unique sound when plucked or struck;
wherein the front soundboard is resilient and in the shape of a shallow dome having a first curvature, whereby when under tension from the strings the front soundboard may be deformed to a relatively flat condition wherein the front soundboard is able to deflect inward away from the strings or outward towards the strings as a result of tension and vibration from the strings, whereby a “steel drum effect” is established with the front soundboard for increased volume and sustain of notes played by a user; and
whereby when one of the strings is plucked vibration therefrom is transmitted through the front soundboard, around the side wall, and into the rear diaphragm to amplify the sound of the plucked string;
whereby the body acts as a whole-body soundboard matrix.

3. The stringed instrument of claim 2 wherein the rear diaphragm is neutrally tensioned, such that vibrations of the strings transmitted directly through the internal volume or through the front soundboard and side wall cause the rear soundboard and rear diaphragm to vibrate with a higher amplitude than the front soundboard.

4. The stringed instrument of claim 2 wherein the stringed instrument further includes:
a neck, a heel fixed at a proximal end thereof, a string nut fixed at a distal end thereof, the heel adapted for engagement with a recessed shoe of the body;
a tuning head projecting away from the string nut and including a plurality of tuning mechanisms; and
the plurality of strings stretched between the string anchor pins, over a saddle in a string bridge, over the neck, a plurality of frets and the string nut, terminating at the tuning mechanisms;
whereby strumming at least one of the strings results in sound waves amplifying within the internal volume and the body, driving the rear diaphragm and the whole-body soundboard matrix.

5. The stringed instrument of claim 4 wherein the front soundboard further includes a primary sound aperture fixed between the recessed shoe of the body and the string bridge.

6. The stringed instrument of claim 4 wherein the front soundboard further includes at least one alternate sound aperture located proximally to the string bridge and straddling an internal harp bracing structure.

7. The stringed instrument of claim 2 wherein the internal volume includes at least one internal partition and contoured internal surfaces that create a switch-backed megaphonic horn that leads to at least one alternate sound aperture in the soundboard positioned generally between a string bridge and the side wall.

8. The stringed instrument of claim 4 wherein the saddle extends from the bridge, presents a peak projecting away from the front soundboard, a distal side and a proximal side of the bridge each sloped towards the front soundboard, the proximal side including a plurality of the string anchor pins each securing one of the strings.

9. The stringed instrument of claim 4 wherein the bridge includes at least one saddle and is fixed through the front soundboard to an internal harp-style frame that allows the bridge and saddle to accommodate up to hundreds of pounds of tensile force within the strings while allowing the front soundboard to transfer vibration from the strings through the domed front soundboard, through the first curved interface, through the radiused side wall, through the second curved interface, through the rear soundboard and into the rear diaphragm, both the rear soundboard and the rear diaphragm acting in concert to amplify the sound;
whereby the entire body becomes the stand-alone dynamic integrated matrix soundboard amplifier.

10. The stringed instrument of claim 8 wherein the string anchor pins allow a barrel-end terminator of the strings to directly contact the bridge along a contact area thereof, thereby providing an increased mechanical advantage and connection between the bridge and the strings for imparting vibration from the strings to the front soundboard.

11. The stringed instrument of claim 4 wherein the first curved shallow domed front soundboard is resilient, whereby under tension from the strings the front soundboard may be deformed to a relatively flat condition wherein the front soundboard is able to deflect inward away from the strings or outward towards the strings as a result of variations in tension and vibration from the strings, whereby a “steel drum effect” is established with the front soundboard for increased volume and sustain of notes played by a user and increased deformation of the side walls through the catenary effect of the domed front soundboard moving in and out of the stringed instrument body.

12. The stringed instrument of claim 11 wherein the rear diaphragm moves inwardly and outwardly corresponding to the flexing and vibration of the front soundboard, the first and second curved interfaces of the side wall driving the rear soundboard and rear diaphragm with amplification.

13. The stringed instrument of claim 11 further including a monolithic internal harp-style frame within the internal volume that extends laterally not as far as the bridge, whereby the vibration-to-sound efficiency is increased from the strings to the front soundboard and the structural integrity of the body is maintained when under tension from the strings.

14. The stringed instrument of claim 4 further including at least one resilient user standoff fixed in close proximity to the rear diaphragm and adapted to hold the body of the stringed instrument away from the body of a user to prevent contact therebetween that results in sound attenuation therefrom.

15. A stringed instrument, comprising:
a substantially hollow body including a front soundboard, a rear soundboard having a rear diaphragm, and a side wall, all defining an internal volume, the internal volume having a first curved interface between the side wall and the front soundboard having a second curvature, and a second curved interface between the side wall and the rear diaphragm having a forth curvature; and
a plurality of strings fixed with the body, each adapted to produce a unique sound when plucked or struck;
the front soundboard being resilient and in the shape of a shallow dome;
whereby when under tension from the strings the front soundboard is deformed to a relatively flat condition wherein the front soundboard is able to deflect inward away from the strings or outward towards the strings as a result of tension and vibration from the strings, whereby an “steel drum effect” is established with the front soundboard for increased volume and sustain of notes played by the user, such that when one of the strings is plucked vibration therefrom is transmitted through the front soundboard, around the side wall, and into the rear diaphragm to amplify the sound of the plucked string.

16. The stringed instrument of claim 15 wherein the rear diaphragm is neutrally tensioned, such that vibrations of the strings transmitted directly through the internal volume or through the front soundboard and side wall cause the rear diaphragm to vibrate with a higher amplitude than the front soundboard and the rest of the rear soundboard.

17. The stringed instrument of claim 15 wherein the stringed instrument further includes:
a neck, a heel fixed at a proximal end thereof, a string nut at a distal end thereof, the heel adapted for engagement with a recessed shoe of the body;
a tuning head projecting away from a string nut and including a plurality of tuning mechanisms; and
the plurality of strings fixed between the string bridge and the tuning mechanisms, each string positioned over the string nut, the neck, and a saddle of the string bridge;
whereby strumming at least one of the strings results in sound waves amplifying within the internal volume of the body and driving the rear diaphragm.

18. The stringed instrument of claim 17 wherein the front soundboard further includes a primary sound aperture fixed between the recessed shoe fixed with the body and the string bridge.

19. The stringed instrument of claim 17 wherein the internal volume includes at least one internal partition and contoured internal surfaces that create a switch-backed megaphonic horn that leads to at least one alternate sound aperture in the soundboard positioned generally between the string bridge and the side wall.

20. The stringed instrument of claim 17 wherein the bridge includes the saddle projecting away from the front soundboard, a distal side and a proximal side thereof each sloped towards the front soundboard, the proximal side including a plurality of string anchor pins each fixed with one of the strings.

21. The stringed instrument of claim 20 wherein the bridge is fixed through the front soundboard to an internal harp-style frame that allows the bridge and saddle to accommodate up to 350 pounds of tensional force within the strings while allowing the front soundboard to transfer vibration from the strings through the front soundboard, through the first curved interface, through the side wall, through the second curved interface, through the rear soundboard and into the rear diaphragm, both the rear soundboard and the rear diaphragm acting in unison to amplify the sound.

22. The stringed instrument of claim 17 wherein the further including an internal strut that supports the shoe and facilitates both securing the heel of the neck to the body with a plurality of fasteners, and also communicating string tension vibrations entering the distal end of the neck into the body.

23. The stringed instrument of claim 22 wherein the strut further includes a plurality of micro adjustment screws to allow fine adjustment of the tension and position of the neck with respect to the body.

24. The stringed instrument of claim 20 wherein the string anchor pins allow a barrel-end terminator of the strings to directly contact the bridge along a contact area thereof, thereby providing an increased mechanical connection between the bridge and the strings for imparting vibration from the strings to the front soundboard.

25. The stringed instrument of claim 15 wherein the rear diaphragm moves inwardly and outwardly corresponding to the flexing and vibration of the front soundboard, the first and second curved interfaces of the side wall driving the rear diaphragm with amplification.

26. The stringed instrument of claim 15 further including a monolithic internal harp-style frame within the internal volume that extends laterally not as far as the bridge and saddle, whereby the vibration-to-sound efficiency is increased from the strings to the front soundboard and the structural integrity of the body is maintained when under tension from the strings.

27. The stringed instrument of claim 17 further including at least one user resilient standoff fixed with the rear diaphragm and adapted to hold the body of the stringed instrument away from the body of the user to prevent contact therebetween and resulting sound attenuation therefrom.
